(19) United States
(12) Patent Application Publication
(10) Pub. No.: US 2002/0108843 A1
(43) Pub. Date: Aug. 15, 2002

(54) Operating button transilluminated from its rear side and method for its production

(75) Inventors: Jorg Reinhardt, Lahnau (DE); Michael Romer, Staufenberg (DE); Joachim Spratte, Osnabruck (DE)

Correspondence Address: COHEN, PONTANI, LIEBERMAN & PAVANE, Suite 1210, 551 Fifth Avenue, New York, NY, 10176, US

(73) Assignee: Siemens Aktiengesellschaft

(21) Appl. No.: 10/027,989

(22) Filed: Dec. 20, 2001

(30) Foreign Application Priority Data
Dec. 21, 2000 (DE) 100 63 872.4

(51) Int. Cl. H01H 9/00

(52) U.S. Cl. 200/314

(57) ABSTRACT

The basic body is injection molded of a transparent material. Its rear side is provided with an opaque coating, which has apertures which are produced by means of laser light and are covered by a colored layer.

### BACKGROUND OF THE INVENTION

1. Field of the Invention

The invention relates to an operating button which can be transilluminated from its rear side, in particular for a car radio, which has a basic body made of a transparent or translucent material, on one side of which an opaque coating is applied, having at least one aperture to produce a marking. Furthermore, the invention relates to a method of producing such an operating button.

2. Description of the Related Art

Operating buttons were previously produced by providing a symbol carrier with a transparent covering, in particular made of glass. The covering at the same time protected the symbol carrier from soiling. Furthermore, the covering had the advantage that it was much more resistant to wear than the symbol carrier, with the result that, even after frequent actuation of the operating button, the symbol was not worn and therefore remained easy to read even when the button was continually in use.

For cost reasons, the previously customary design of operating buttons can today only be used in exceptional cases. Therefore, at present, a transparent basic body is provided on the side facing the user with an opaque layer and the markings required are applied there, for example by an inscription, in that the opaque layer is removed by laser light at the required locations. A disadvantage of this is that, if the operating button is frequently in use, the opaque layer is worn away and the inscription becomes illegible as a result. Furthermore, an opaque inscription does not allow a high-gloss surface to be produced.

### SUMMARY OF THE INVENTION

The invention is based on the problem of designing an operating button whose marking can still be read even after long use and which has a high-gloss surface. Furthermore, a method of producing such an operating button is to be developed.

The first-mentioned problem is solved according to the invention by the opaque coating being provided on the rear side of the basic body, at least one aperture being provided in the opaque coating.

This design has the effect that, when the operating button is used, it is not the opaque layer, usually applied by painting, but the transparent basic body that is touched. As a result, the marking is not subject to being worn away by actuation of the operating button. Since the translucent basic body can be produced from a high-gloss plastic at low cost, the operating button according to the invention has a high-gloss surface with an advantageous appearance and, by giving the effect of greater depth, the inscription has a look reminiscent of earlier times (retro design).

An advantageous development of the invention is that a colored translucent layer is applied to the opaque coating, at least in the region of the aperture. Such a colored layer makes it possible to homogenize the light passing through the operating button and make it any desired color, for example white.

The operating button has an especially advantageous visual effect if, according to another development of the invention, the translucent layer reaches into the aperture right up to the basic body of the operating button.

The second-mentioned problem, that is the development of a method of producing an operating button, in particular for a car radio, in which firstly a basic body is injection-molded from transparent material and subsequently this basic body is provided with an opaque coating, in which at least one aperture is then produced by means of laser light to produce a marking, is solved according to the invention by the opaque layer being applied to the rear side of the basic body.

This procedure is not any more expensive than the previously used procedure of applying the coating, and consequently also the inscription, to the front side of the operating button, but has the effect that the marking cannot be worn away and altogether obtains a more advantageous appearance.

The invention allows various embodiments. To illustrate its basic principle further, one of these is represented in the drawing in various stages of production, in section in each case, and is described below.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a basic body of the operating button;

FIG. 2 shows a section through the basic body with a coating applied to the rear side;

FIG. 3 shows the basic body with the coating and apertures formed therein; and

FIG. 4 shows the operating button in the final state.

### DETAILED DESCRIPTION OF THE PRESENTLY PREFERRED EMBODIMENTS

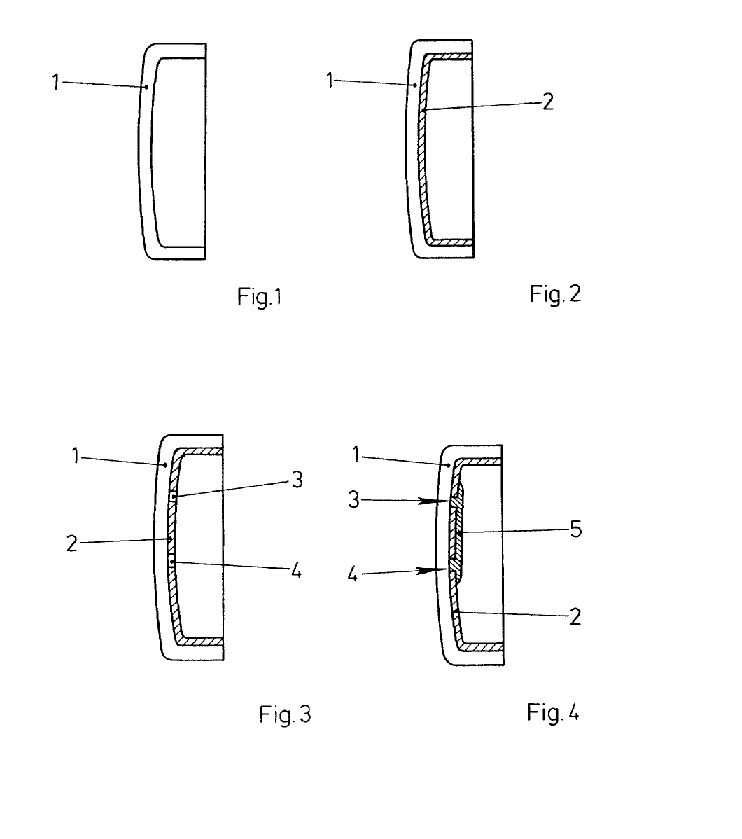

FIG. 1 shows a basic body 1 comprising a highly translucent and transparent material, which is designed in the form of a cap.

FIG. 2 illustrates that a coating 2 of an opaque, 35 preferably black, material has been applied to the rear side of the basic body over its full surface area, which can take place for example by painting.

In FIG. 3 it can be seen that apertures 3, 4 have been produced in the coating 2, which is performed by means of laser light, by burning away the coating 2 by means of the light at the corresponding locations. The apertures 3, 4 form a marking of the operating button, for example an inscription or a symbol.

After producing the apertures 3, 4, a colored, for example white, layer 5 is applied to the coating 2, this layer covering the apertures 3, 4 and reaching into them right up to the basic body 1, which is illustrated by FIG. 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. An operating button for a car radio, said operating button comprising
a basic body of light transmissive material, said basic body having a front side which is contacted by a user for operation and an opposed rear side, and
an opaque coating applied to said rear side, said opaque coating having at least one aperture therein, whereby
illumination of said rear side is visible from said front side through said at least one aperture.

2. An operating button as in claim 1 further comprising a translucent layer applied to said opaque coating at least over said at least one aperture.

3. An operating button as in claim 2 wherein said translucent layer fills said at least one aperture up to the basic body.

4. A method of producing an operating button which can be illuminated from the rear side, said method comprising
injection molding a basic body of light transmissive plastic, said basic body having a front side and a rear side,
providing the rear side of said basic body with an opaque coating, and
producing at least one aperture in said opaque coating by means of laser light.
